(19) United States
(12) Patent Application Publication
(10) Pub. No.: US 2011/0297023 A1
(43) Pub. Date: Dec. 8, 2011

(54) APPARATUS AND METHOD FOR PRODUCING NEWSPAPERS FROM A PRINTED WEB

(75) Inventor: Jochen Dieter Meissner, Durham, NH (US)

(73) Assignee: Goss International Americas, Inc., Durham, NH (US)

(21) Appl. No.: 13/104,672

(22) Filed: May 10, 2011

Related U.S. Application Data
(60) Provisional application No. 61/396,896, filed on Jun. 4, 2010.

(51) Int. Cl. B41F 13/54

(52) U.S. Cl. 101/228; 101/483

(57) ABSTRACT

A printing press is provided that includes at least one printing unit printing on a plurality of successive web portions. Each of the web portions is printed with a plurality of groups of pages and each web portion is printed with different content than at least one other of the plurality of web portions. The printing press also includes a storage apparatus receiving the web portions and storing the web portions separately from one another and a folder receiving the web portions from the storage apparatus and processing the web portions into a plurality of printed products. Each of the printed products includes one group of pages from each of the web portions. A method of creating newspapers is also provided.

This claims the benefit of U.S. Patent Application No. 61/396,896, filed Jun. 4, 2010 and hereby incorporated by reference herein.

The present invention relates generally to printing presses and more specifically to a method and apparatus for forming newspapers from a printed web.

### BACKGROUND OF THE INVENTION

Traditional broadsheet newspapers include varying numbers of pages in varying numbers of sections, produced at high speeds using folders that are designed to fold the webs lengthwise, cut the folded webs into books, and then cross-fold the books. Each group of pages is printed on a separate web and each web is supplied separately to the folder (depending on the format of the units printing the pages), so that up to twelve webs, printed by twelve different print units, may be supplied simultaneously into one folder.

When printed pages are produced digitally, it is desirable to sequentially produce different groups of pages on one web, so that in theory, the newspaper that is traditionally printed on up to twelve webs can now be printed on one web. FIG. 1a shows a top and a bottom view of an example of a conventional digital printing technique of sequentially printing different groups of pages on one web 12′ traveling in a direction 11′. The sequentially printed groups are then converted into one newspaper 18′ (FIG. 1b) or section of a newspaper. A perfecting printing unit 10′ prints images on both sides of web 12′. In this example, printing unit 10′ is printing sixteen page newspapers on web 12′, with eight pages A′, C′, E′, G′, L′, N′, P′ being printed on a first or bottom side of web 12′ and eight pages B′, D′, F′, H′, I′, K′, M′, O′ being printed on a second or top side of web 12′. After printing, web 12′ is cross-cut along lines 14a′, 14b′, 14c′, 14d′ to separate subportions 12a′, 12b′, 12c′ 12d′ of web 12′ from each other. The separated subportions 12a′, 12b′, 12c′ 12d′ are then stacked together and longitudinally folded together along a folding line 15′ of each subportion 12a′, 12b′, 12c′ 12d′ to form four folded sheets 16a′, 16b′, 16c′, 16d′ (FIG. 1b), each including different content. First sheet 16a′ may include a first group of four pages A′, B′, O′, P′, second sheet 16b′ may include a second group of four pages C′, D′, M′, N′, third sheet 16c′ may include a third group of four pages E′, F′, K′, L′ and fourth sheets 16d′ may include a fourth group of four pages G′, H′, I′, F. Sheets 16a′, 16b′, 16c′, 16d′ may be gathered to form a sixteen page newspaper 18′, shown in FIG. 1B, which may then be cross-folded. Sheets 16a′, 16b′, 16c′, 16d′ are arranged in newspaper 18′ such that the pages A′ to P′ are in alphabetical order when read in a traditional manner.

Printing unit 10′ prints pages A′, B′, O′, P′ in first web subportion 12a′, pages C′, D′, M′, N′ in second web subportion 12b′ directly following web subportion 12a′, pages E′, F′, K′, L′ in third web subportion 12c′ directly following web subportion 12b′ and pages G′, H′, I′, J′ in fourth web subportion 12d′ directly following web subportion 12c′. At this time, printing unit 10′ has finished printing an entire sixteen page newspaper 18′ and then begins printing another sixteen page newspaper 18′ in web subportions 12e′ to 12h′. Web subportions 12e′ to 12h′ are printed with pages A′ to P′, longitudinally folded along a folding line 15′ and cross-cut along lines 14e′, 14f′, 14g′, 14h′ to form four successive sheets 16a′, 16b′, 16c′, 16d′ that are gathered to form another newspaper 18′. The process continues with printing unit 10′ printing images on pages A′, B′, O′, P′ in a web subportion 12i′ and proceeds in the manner described above until a desired number of sixteen page newspapers 18′ have been produced.

### BRIEF SUMMARY OF THE INVENTION

A printing press is provided that includes at least one printing unit printing on a plurality of successive web portions. Each of the web portions is printed with a plurality of groups of pages and each web portion is printed with different content than at least one other of the plurality of web portions. The printing press also includes a storage apparatus receiving the web portions and storing the web portions separately from one another and a folder receiving the web portions from the storage apparatus and processing the web portions into a plurality of printed products. Each of the printed products includes one group of pages from each of the web portions.

A method of creating newspapers is also provided. The method includes printing on a plurality of successive web portions. Each of the web portions is printed with a plurality of groups of pages and each web portion is printed with different content than at least one other of the plurality of web portions. The method also includes storing the web portions, longitudinally folding the web portions and merging the longitudinally folded web portions together, and cutting the merged longitudinally folded web portions into a plurality of printed products. Each of the printed products includes one group of pages from each of the web portions.

### BRIEF DESCRIPTION OF THE DRAWINGS

The present invention is described below by reference to the following drawings, in which:

FIG. 1a shows a top and a bottom view of an example of a conventional digital printing technique of sequentially printing different groups of pages on one web;

FIG. 1b shows a perspective view of a newspaper formed from the printing technique shown in FIG. 1a;

FIG. 2a shows a top and a bottom view of a printing technique according to an embodiment of the present invention;

FIG. 2b shows a perspective view of a newspaper formed from the printing technique shown in FIG. 2a; and

FIGS. 3 and 4 schematically show a printing press according to an embodiment of the present invention.

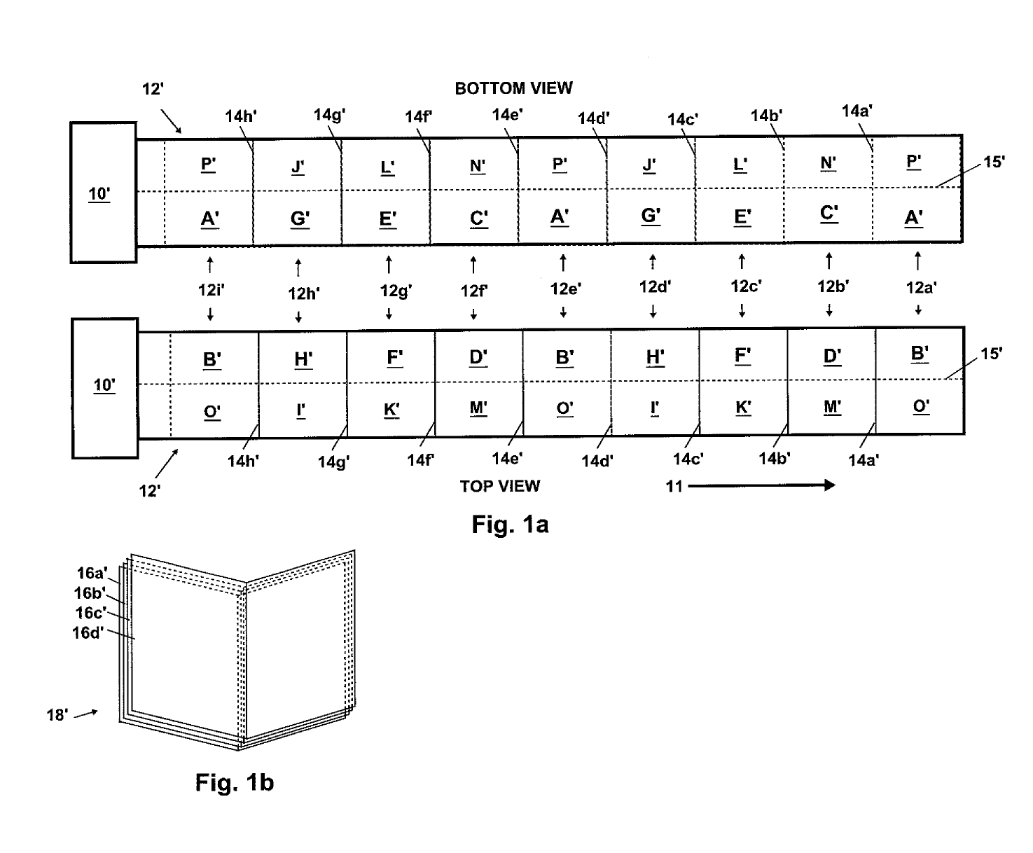

### DETAILED DESCRIPTION

Traditional newspaper folders are unable to produce completed newspapers from one web, because their underlying principle is to print and combine multiple page groups simultaneously, not sequentially. Conventional digital presses print newspapers by printing all of the groups of pages for one newspaper successively on a number of webs, followed directly by all of the groups of pages for a following newspaper on the same number of webs. It would be advantageous to be able to use a conventional folder to fold newspapers printed from a single web. This would be particularly useful for short run newspaper products.

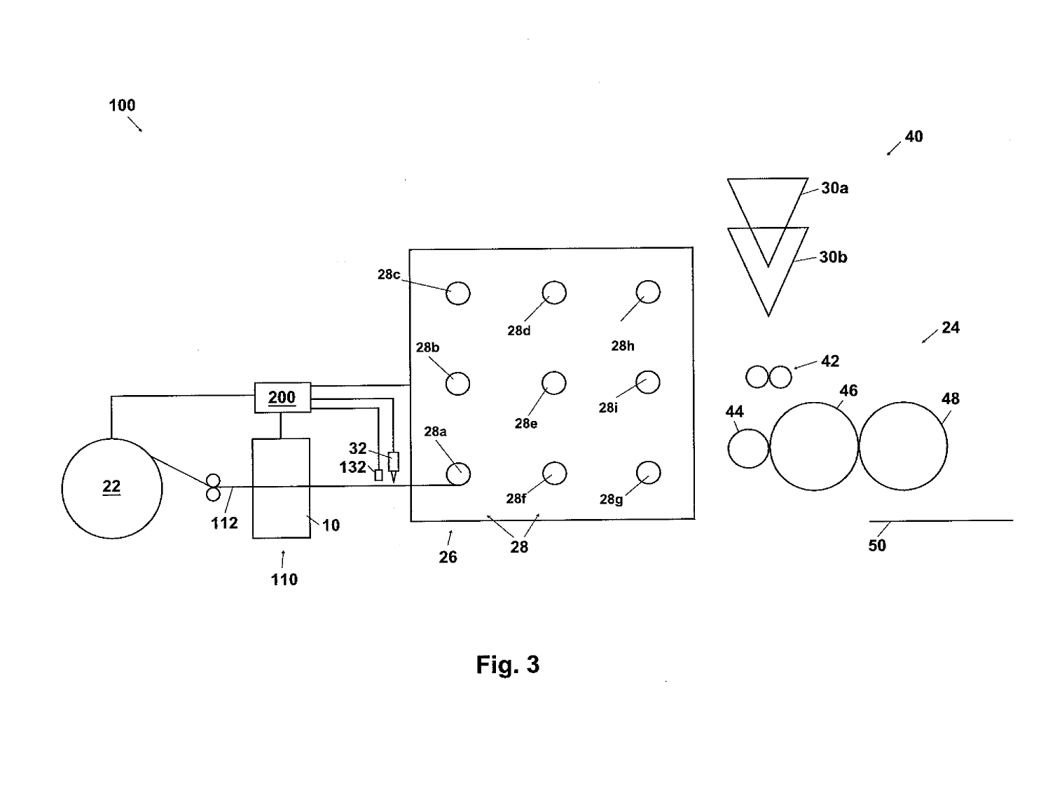

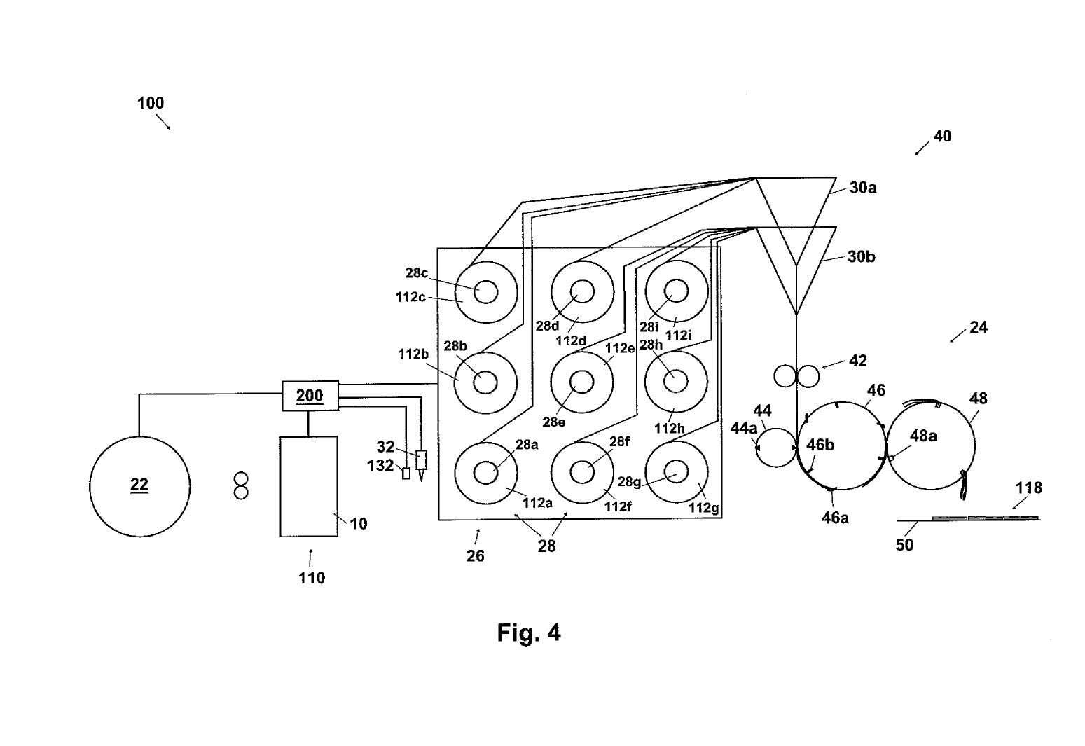

The printing technique of the embodiments of the present invention discussed below may be advantageously used to print in short runs, i.e., print jobs that include a small number of printed products. A first group of pages, all of which include the same content, is printed repeatedly on a first portion of one web until the number of the first group of pages printed equals the desired number of newspapers. Then, a next group of pages, all of which include the same content that is different from the content of the first group of pages, is printed for each newspaper following the first group of pages on a second portion of the same web that directly follows the first web portion. The second group of pages is printed repeatedly on the second portion of the web until the number of the second group of pages printed on the web equals the number of the first group of pages printed on the web. As discussed below with respect to FIGS. 3 and 4, each portion including one group of pages printed repeatedly thereon, is then wound on one of a plurality of storage rolls. After all of the different groups of pages for the each newspaper have been printed on respective successive web portions and stored on respective storage rolls, all the web portions are brought together so that the different groups of pages are folded and combined to form newspapers, with each newspaper including one group of pages from each of the different web portions.

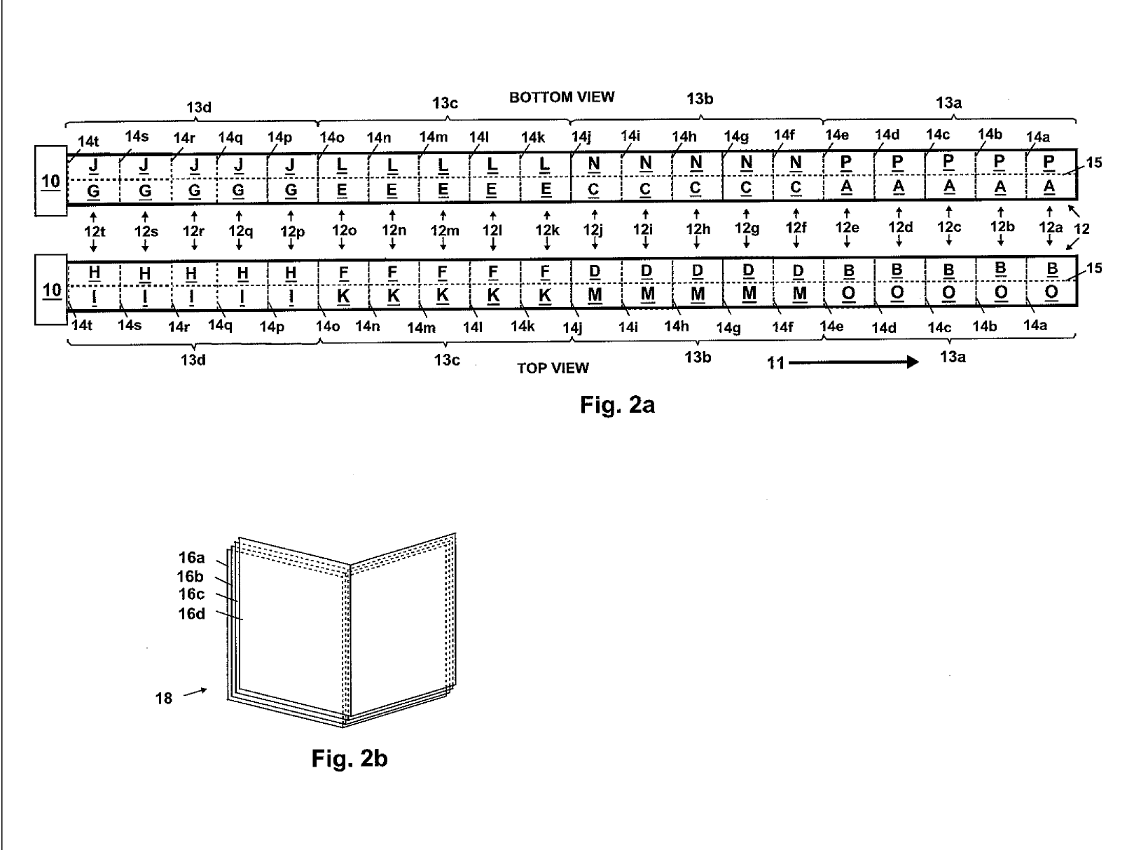

FIG. 2a shows a top and a bottom view of a printing technique according to an embodiment of the present invention that may be used to produce a plurality of printed products, which in a preferred embodiment are broadsheet newspapers. In this example, a perfecting printing unit 10, which is shown schematically, prints images on both sides of a web 12 traveling in a direction 11 to form contents of sixteen page newspapers on web 12, with eight pages A, C, E, G, J, L, N, P being printed on a first or bottom side of web 12 and eight pages B, D, F, H, I, K, M, O being printed on a second or top side of web 12. Although a single printing unit 10 is described in accordance with this embodiment, it should be noted that a plurality of printing units may be used to print multiple colored images on web 12.

Printing unit 10 begins by repeatedly printing the first group of pages A, B, O, P for all five of the newspapers 18 (FIG. 2b) to be produced, then, after all of the first group of pages A, B, O, P are printed, printing the second group of pages C, D, M, N for all five of the newspapers 18 to be produced directly following the last of the pages A, B, O, P, then, after all of the second group of pages C, D, M, N are printed, printing the third group of pages E, F, K, L for all five of the newspapers 18 to be produced directly following the last of the pages C, D, M, N and finally, after all of the third group of pages E, F, K, L are printed, printing the fourth group of pages G, H, I, J for all five of the newspapers 18 to be produced directly following the last of the pages E, F, K, L. As shown in FIG. 2a, printing unit 10 prints a first group of pages A, B, O, P repeatedly in a first portion 13a of web 12 such that printing unit 10 prints pages A, B, O, P each in a first web subportion 12a, in a second web subportion 12b directly following web subportion 12a, in a third web subportion 12c directly following web subportion 12b, in a fourth web subportion 12d directly following web subportion 12c and in a fifth web subportion 12e directly following web subportion 12d.

After printing the first group of pages A, B, O, P for all five of newspapers 18 (FIG. 2b), printing unit 10 then prints all of the second group of pages C, D, M, N for all five of newspapers 18, printing pages C, D, M, N repeatedly in a second portion 13b of web 12 such that printing unit 10 prints pages C, D, M, N in each of web subportions 12f, 12g, 12h, 12i, 12j. After printing the second group of pages for all five of newspapers 18, printing unit 10 then prints all of the third group of pages E, F, K, L for all five of newspapers 18, printing pages E, F, K, L repeatedly in a third portion 13c of web 12 such that printing unit 10 prints pages E, F, K, L in each of web subportions 12k, 12l, 12m, 12n, 12o. After printing the third group of pages for all five of newspapers 18, printing unit 10 then prints all of the fourth group of pages G, H, I, J for all five of newspapers 18, printing pages G, H, I, J repeatedly in a fourth web portion 13d of web 12 such that printing unit 10 prints pages G, H, I, J in each of web subportions 12r, 12q, 12p, 12s, 12t. After printing unit 10 prints all five sets of the fourth group of pages G, H, I, J, printing unit 10 has printed all of the contents of five sixteen page newspapers 18 on web 12.

In this exemplary embodiment, printing unit 10 is printing the contents of five newspapers 18 (FIG. 2b) on web 12; however, the technique described herein may be used to print many more newspapers, at least hundreds or thousands. After printing each of successive web portions 13a, 13b, 13c, 13d, web 12 is cut along a respective line 14e, 14j, 14o, 14t after the respective web portion 13a, 13b, 13c, 13d exits printing unit 10, and web portions 13a, 13b, 13c, 13d are successively brought to a storage apparatus 26 (FIGS. 3 and 4) so each web portion 13a, 13b, 13c, 13d may be stored separately in storage apparatus 26. Web portions 13a, 13b, 13c, 13d may then be lead out of storage apparatus 26 at the same time and longitudinally folded along a folding line 15 by one or more formers 30a, 30b (FIGS. 3 and 4). Folding line 15 divides pages A, C, E, G from pages J, L, N, P on one side of respective web portions 13a, 13b, 13c, 13d and divides pages B, D, F, H, from pages I, K, M, O on the other side of respective web portions 13a, 13b, 13c, 13d. Then, with the lead edges of subportions 12a, 12f, 12k, 12p aligned with one another and web portion 13a, 13b, 13c, 13d superimposed on each other, web portions 13a, 13b, 13c, 13d are all cut together. First, web portions 13a, 13b, 13c, 13d are all cross cut together at the same time along lines 14a, 14f, 14k, 14p to form a first newspaper 18 (FIG. 2b), second, web portions 13a, 13b, 13c, 13d are all cut together at the same time along lines 14b, 14g, 141, 14q to form a second newspaper 18, third, web portions 13a, 13b, 13c, 13d are all cut together at the same time along lines 14c, 14h, 14m, 14r to form a third newspaper 18, and fourth, web portions 13a, 13b, 13c, 13d are all cut together at the same time along lines 14d, 14i, 14n, 14s to form a fourth newspaper 18 and a fifth newspaper 18.

As shown in FIG. 2b, each newspaper 18 in this exemplary embodiment includes sixteen pages which are formed by four sheets 16a, 16b, 16c, 16d. All of subportions 12a to 12e form first sheets 16a, each including a first group of four pages A, B, O, P, all of subportions 12f to 12j form second sheets 16b, each including a second group of four pages C, D, M, N, all of subportions 12k to 12o form third sheets 16c, each including a third group of four pages E, F, K, L and all of subportions 12p to 12t form fourth sheets 16d, each including a fourth group of four pages G, H, I, J. Sheets 16a, 16b, 16c, 16d are arranged in newspaper 18 such that the pages A to P are in alphabetical order when read in a traditional manner. Accordingly, sheet 16a includes first page A, second page B, second to last page O and last page P, sheet 16b includes third page C, fourth page D, fourth to last page M and third to last page N, sheet 16c includes fifth page E, sixth page F, sixth to last page K, and fifth to last page L and sheet 16d includes seventh page G, eighth page H, eighth to last page 1, and seventh to last page J.

It should be noted that web portions 13a to 13d do not have to be printed with the content of sheets 16a to 16d in the order that sheets 16a to 16d appear in newspaper 18, but rather may be printed in any convenient order, as long as web portions 13a to 13d are subsequently superimposed correctly as web portions 13a to 13d are longitudinally folded. For example, the content sheets 16a, which includes first page A, second page B, second to last page O and last page P, does not have to be printed on web 12 before the content of sheets 16b, 16c, 16d. The content of any of sheets 16a (pages A, B, O, P), sheets 16b (pages C, D, M, N), sheets 16c (pages E, F, K, L), sheets 16d (pages G, H, I, J) may be repeatedly printed first on web 12 at web portion 13a, followed by any of sheets 16a, 16b, 16c, 16d repeatedly printed on web 12 at web portion 13b directly following web portion 13a. This is a distinct advantage in terms of when the printing of newspapers 18 may begin, in that the content for some of sheets 16a, 16b, 16c, 16d may be available earlier than that of other sheets 16a, 16b, 16c, 16d—and not in the order of sheets 16a, 16b, 16c, 16d in the eventual newspaper 18. For example, if the content of pages E, F, K, L is available first, the content of sheets 16c may be printed in web section 13a. The press operator does not have to wait until the content of any specific sheet of newspaper 118 is available before the printing may begin.

If an operator of a printing press including printing unit 10, for example a printing press 100 shown in FIGS. 3 and 4, wishes to print five hundred newspapers 18 (FIG. 2b), the operator may use a human-machine interface such as a keyboard and/or mouse and/or a touch screen of a controller 200 (FIGS. 3 and 4) to input the number of newspapers 18 into controller 200. Controller 200 then directs printing unit 10 to print five hundred sets of the first group of pages A, B, O, P on web 12 in the five hundred consecutive web subportions, which are directly followed by five hundred sets of the second group of pages C, D, M, N in the next five hundred consecutive web subportions, which are directly followed by five hundred sets of the third group of pages E, F, K, L in the next five hundred consecutive web subportions, which are directly followed by five hundred sets of the fourth group of pages G, H, I, J in the next five hundred consecutive web subportions. Accordingly, after all of the five hundred sets of the fourth group of pages G, H, I, J are printed on web 12, printing unit 10 has printed the content of all five hundred newspapers 18 on web 12.

FIGS. 3 and 4 schematically show printing press 100 according to an embodiment of the present invention. Printing press 100 includes a printing section 110 having at least one printing unit 10 and may advantageously create successive complete newspapers 118 out of a single web 112 by sequentially printing different groups of pages on respective successive web portions 112a to 112i of web 112 as described above with respect to FIG. 2a. In the exemplary embodiment described with respect to FIGS. 3 and 4, each newspaper 118 is composed of nine different groups of pages, each group including four pages, and for example two thousand newspapers 118 including thirty six pages may be produced. The thirty six pages of each newspaper 118 may include the same or different content as the other newspapers 118 depending on the particular print job.

As shown in FIG. 3, printing press 100 includes a roll supply 22 for supplying web 112 to printing unit 10, which in this embodiment is preferably a digital printing engine, for example an electrophotographic or ink jet printing engine. Controller 200, which may include a memory that stores information regarding the content to be printed in each subportion of web 112, may control printing unit 10 to ensure that the proper content is printed as desired on web 112. For example, if the press operator is running a print job that requires all of the two thousand newspapers 118 to include the exact same content, the press operator may directly or indirectly provide the print job data to controller 200 and controller 200 directs print unit 10 to print a first group of pages on web 112 two thousands times sequentially. After print unit 10 prints the first group of pages two thousand times, controller 200 directs print unit 10 to print the second group of pages two thousand times on web 112. The process is then continued until each of the nine group of pages is printed the appropriate number of times on web 112. For example, if the press operator is running a print job that requires at least some of the two thousand newspapers 118 to include at least some varying content, the press operator may directly or indirectly provide the print job data to controller 200 and controller 200 directs print unit 10 to print a first group of pages on web 112 two thousands times successively according to the customized plan for each printed product. For example, each newspaper 118 may include personalized content on each of the thirty six pages based on the preferences of a specific customer or newspaper 118 may include most of the same content and include personalize content on only one or a few of the thirty six pages. Also, newspapers 118 may be made for two or more different groups. For example, four hundred of the two thousand newspapers 118 may include some customized content for a first group, seven hundred newspapers 118 may include some customized content for a second group and nine hundred newspapers 118 may include some customized content for a third group.

After web 112 is printed by printing unit 10, web 112 is directed to a storage apparatus 26 including a plurality of rewind units 28, for example nine rewind units 28a to 28i. A lead edge of web 112 may be directed into storage apparatus 26 using a plurality of side-grippers, for example those disclosed in U.S. Pat. No. 6,923,119, which is hereby incorporated by reference herein, contacting the side edges of web 112 or transport tapes contacting the top and bottom of web 112. A first web portion 112a, including two thousand successive subportions that are each printed with a first group of pages, may be provided to a first rewind unit 28a. After first web portion 112a is printed with the content for all two thousand sets of the first group of pages, web 112 is cut by a portion cutter 32 at the end of first web portion 112a (i.e., at a trailing edge of the two thousandth subportion of the first group of pages), creating a leading edge of a second web portion 112b following first web portion 112a, to separate first web portion 112a from web 112. Portion cutter 32 may be controlled by controller 200 based on directions printed on web 112 by printing unit 10. At the end of first web portion 112a, printing unit 10 may print a code on web 112 indicating the end of first web portion 112a. A sensor 132 may read the code and direct, via controller 200 or an additional controller, portion cutter 32 to cut web 112. In alternative embodiments, portion cutter 32 may be positioned inside of storage apparatus 26 or a plurality of portion cutters 32 may be positioned inside of storage apparatus 26. If a plurality of portion cutters 32 are used, one portion cutter 32 may be provided for each rewind unit 28 or one portion cutter 32 may be provided for each row or column of rewind units 28.

Web 112 is then guided to a second rewind unit 28b so that second web portion 112b, printed with sets of the second group of pages, is rewound around second rewind unit 28b. The guiding of web 112 to second rewind unit 28b may be accomplished by moving first rewind unit 28a from an entrance of storage apparatus 26 and positioning second rewind unit 28b at the entrance of storage apparatus 26. Rewind units 28a to 28i, at the ends thereof, may be slidably mounted in a frame of storage apparatus 26 and may be moved in and out of the entrance position of storage apparatus 26 manually or by electromechanical actuators controlled by controller 200. The positions of rewind units 28a to 28i may be controlled as a function of the code printed on web 112 and read by sensor 132. Accordingly, the code printed on web 112 may include timing information for portion cutter 32 and storage apparatus 26, along with information regarding which rewind unit 28a to 28i needs to be moved into the entrance position. A temporary web storage section may be provided near the entrance of storage apparatus 26 to temporarily store web 112 as the next rewind unit 28a to 28i is moved into the entrance position.

In one alternative embodiment, rewind units 28a to 28i may not be moved during the switch from one of rewind units 28a to 28i to the next and storage apparatus 26 may include diverters, which may be controlled by controller 200 based on the codes read by sensor 132, spaced at intervals therein for directing web 112 to the appropriate rewind unit 28a to 28i. In such an embodiment, appropriately aligned side-grippers, rollers, turning bars and/or transport tapes may also be included in storage apparatus 26 to guide each web portion 112a to 112i to the corresponding rewind unit 28a to 28i. In another alternative embodiment, web portions 112a to 112i may be directed to rewind units 28a to 28i manually by the press operator or operators.

After second web portion 112b is printed with the content for all two thousand sets of the first group of pages, and substantially the entire second web portion 112b is collected by second rewind unit 28b, web 112 is cut by portion cutter 32 at the end of second web portion 112b (i.e., at a trailing edge of the two thousandth subportion of the second group of pages) and at the beginning of third web portion 112c following second web portion 112b to separate second web portion 112b from web 112. This process of rewinding, cutting and redirecting of web 112 is repeated until all of portions 112a to 112i, which include all of the groups of pages of newspapers 118, are collected in storage apparatus 26. A plurality of sensors and controller 200 may be used to ensure that each distinct web portion 112a to 112i is accurately provided on a separate rewind unit 28. Sensors may also inspect web portions 112a to 112i to insure the quality of print going into rewind units 28. Controller 200 may also set the pagination of content printed on web portions 112a to 112i so the pages are in the proper order and orientation in newspapers 118.

As shown in FIG. 4, after all nine web portions 112a to 112i (each including two thousand sets of pages of the respective group of pages) are collected in storage apparatus 26, web portions 112a to 112i are processed in a folder 40. In the embodiment shown in FIG. 4, folder 40 may include an upper former 30a, a lower former 30b and a lower folder 24. A first set of web portions 112a, 112b, 112c, 112d are unwound from respective rewind units 28a, 28b, 28c, 28d, brought together in a desired alignment and threaded into folder 40 by a first automatically controlled threading apparatus or manually by the press operator or operators and a second set of web portions 112e, 112f, 112g, 112h, 112i are unwound from respective rewind units 28e, 28f, 28g, 28h, 28i, brought together in a desired alignment and threaded into folder 40 by a second automatically controlled threading apparatus or manually by the press operator or operators. In this embodiment, the first set of web portions 112a to 112d are delivered to upper former 3 Oa for longitudinal folding as the second set of web portions 112e to 112i are brought from rewind units 28e to 28i are delivered to lower former 30b for longitudinal folding. In one embodiment, only one of formers 30a, 30b may be included for longitudinally folding all of web portions 112a to 112i. In another embodiment, formers 30a, 30b may be offset laterally from one another and longitudinally folded web portions 112a to 112d may aligned adjacent to longitudinally folded web portions 112e to 112i such that the surface of web portion 112c (i.e., the outer web portion of merged and longitudinally folded portions 112a to 112d) contacts the surface of web portion 112e (i.e., the outer web portion of merged and longitudinally folded portions 112e to 112i). Pull rollers 42 below lower former 30b may merge web portions 112a to 112i together for delivery to lower folder 24.

Lower folder 24 may include a cross-cutting device and a cross-folding device. In this embodiment, the cross-cutting device is a cutting cylinder 44 and the cross-folding device includes a tucker cylinder 46 and a jaw cylinder 48. Cutting cylinder 44 successively cross cuts merged web portions 112a to 112i at the same time to form successive newspapers 118. Cutting cylinder 44 includes one or more cutting blades 44a that may be adjustably mounted thereon. Blades 44a contact tucker cylinder 46 as merged web portions 112a to 112i pass between cylinders 44, 46 to cut web portions 112a to 112i into newspapers 118. Each newspaper 118 includes one subportion of each portion 112a to 112i. Grippers 46a on tucker cylinder 46 grip and transport newspapers 118 away from cutting cylinder 44 to jaw cylinder 48, Grippers 46a grip newspapers 118 until tucker cylinder 46 is rotated such that a lead edge of each newspaper 118 is moved past a minimum gap between tucker cylinder 46 and jaw cylinder 48. Tucker blades 46b on tucker cylinder 46 then contact newspapers 118 and force newspapers 118 into corresponding folding jaws 48a on jaw cylinder 48 such that tucker blades 46b and folding jaws 48a cooperate to cross-fold each newspaper 118 at a center line thereof. The cross-folding converts newspapers 118 into folded broadsheet newspapers 118, which are released from jaw cylinder 48 onto a delivery 50.

As similarly discussed above, it should be noted that web portions 112a to 112i do not have to be printed with the content of sheets in the order that the sheets appear in newspapers 118, but rather may be printed in any convenient order, as long as web portions 112a to 112i are subsequently superimposed correctly as web portions 112a to 112i are longitudinally folded in folder 40 as described below. For example, the content of any of sheets of newspaper 118 may be repeatedly printed first on web 112 at web portion 112a, followed by any of the other sheets of newspaper 118 repeatedly printed on web 12 at web portion 112b directly following web portion 112a. This is a distinct advantage in terms of when the printing of newspapers 118 may begin, in that the content for some of sheets of newspaper 118 may be available earlier than that of other sheets of newspaper—and not in the order the sheets appear in the eventual newspaper 118. The press operator does not have to wait until the content of any specific sheet is available before the printing may begin.

Printing press 100 may include any number of rewind units 28 and may advantageously be used to produce broadsheet newspapers with varying section counts and page counts from digitally printed sequential page groups. In an alternative embodiment, newspapers 118 may only be one or more sections of a newspaper and may be combined with other sections to form a full newspaper.

Controller 200 may also ensure that web portions 112a to 112i are appropriately aligned when web portions 112a to 112d are delivered to upper former 30a, when web portions 112e to 112i are delivered to lower former 30b and when web portions 112a to 112i are all merged together at pull rollers 41 Closed-loop register controls may be used to ensure page group synchronization feeding into folder 40. For example, a plurality of sensors, which may be controlled by controller 200 or a separate controller, may be positioned in and at outputs of storage apparatus 26 and throughout folder 40 to ensure web portions 112a to 112i are properly registered with respect to each other.

In other embodiments, printing units 10 may be non-digital printing units such as offset lithographic or flexographic printing units. For variable offset lithographic printing units, printing plates on plate cylinders of printing units 10 may be changed or reimaged between the printing of each separate web portion 112a to 112i. In additional embodiments, any combination of digital, offset lithographic and flexographic printing units may be used and each web 112 may be printed both digitally and non-digitally or web portion 112a to 112i may be printed digitally and may be combined in folder 40 with portions of a further web that are printed non-digitally.

In other embodiments, additional printing sections 110, which may be digital or non-digital, printing on additional webs 112 supplied by respective roll supplies 22 may be used to produce newspapers 118. As similarly discussed above, each web 112 may also be printed by multiple printing units 10 such that each web portion is printed with multicolor images. More than one printing section 110 may be used to provide storage apparatus 26 with web portions simultaneously. For example, storage apparatus 26 may include twelve rewind units 28, with one printing section 110 printing on a first web that includes web portions that are successively supplied to a first set of six rewind units while another printing section 110 prints on a second web that includes web portions that are successively supplied to a second set of six rewind units. Accordingly, the two printing sections 110 may supply twelve different sets of groups of pages to storage apparatus 26 in half the amount of time it would take one printing section 110 to supply twelve different sets of groups of pages to storage apparatus 26. Six of the web portions may then be provided to each former 30a, 30b and the twelve web portions may be merged, cross-cut and cross-folded to form newspapers having forty-eight pages. Alternatively, the additional printing sections 110 may print webs that are combined with the portions of web 112 downstream of storage apparatus 26. For example, one or more additional printing sections 110 may be printing webs that are fed directly to folder 40 at the same time as web portions stored in storage apparatus 26 or the one or more additional printing sections 110 may print one or more additional webs that are stored outside of storage apparatus 26 and fed to folder 40 at the same time as the web portions stored in storage apparatus 26.

In order to maximize the capabilities of printing press 100, printing unit 10, or an additional printing unit 10, may be printing on a web portion being rewound by some of rewind units 28 while others of rewind units 28 are feeding web portions to folder 40. For example, in one embodiment, storage apparatus 26 may include twelve rewind units 28 and a first set of six rewind units may be feeding web portions to folder 40 for producing a first set of twenty-four page newspapers while a second set of six rewind units are successively receiving respective web portions, which include contents of a second set of newspapers, from printing unit 10. Then, after the first set of newspapers are formed and all of the web portions for the second set of newspapers are received on the second set of six rewind units, the web portions for the second set of newspapers may be fed into folder 40 from the second set of six rewind units to form the second set of newspapers while the first set of six rewind units successively receive respective web portions, which include contents of a third set of newspapers, from printing unit 10.

Also, in other embodiments, more than two formers may be used to longitudinally fold web portions 112. Additionally, because printing unit 10 may print in a plurality of different print lengths, one or more additional folders 40 may be provided, with each folder 40 being configured to process a different print length.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

What is claimed is:

1. A printing press comprising:
at least one printing unit printing on a plurality of successive web portions, each of the web portions being printed with a plurality of groups of pages, each web portion being printed with different content than at least one other of the plurality of web portions;
a storage apparatus receiving the web portions and storing the web portions separately from one another; and
a folder receiving the web portions from the storage apparatus and processing the web portions into a plurality of printed products, each of the printed products including one group of pages from each of the web portions.

2. The printing press recited in claim 1 wherein the storage apparatus includes a plurality of rewind units, each of the web portions being stored by one of the rewind units.

3. The printing press recited in claim 1 further comprising a cutter downstream of the at least one printing unit cutting the web to separate the web portions from one another.

4. The printing press recited in claim 1 further comprising a cutter cutting the web to separate the web portions from one another, wherein the storage apparatus includes a plurality of rewind units, the cutter being between the at least one printing unit and the rewind units, the cutter cutting the web at the end of each of the web portion as each web portion is being rewound by a respective one of the rewinds units.

5. The printing press recited in claim 1 wherein the folder includes at least one former longitudinally folding the web portions.

6. The printing press recited in claim 5 wherein the at least one former includes a first former and a second former, the first former folding some of the web portions and the second former folding others of the web portions.

7. The printing press recited in claim 6 wherein the folder includes rollers downstream of the first former and the second former, the web portions folded by the first former and the web portions folded by the second former being merged at the rollers.

8. The printing press recited in claim 5 wherein the folder includes a cross-cutting device cutting the longitudinally folded web portions to form the plurality of printed products.

9. The printing press recited in claim 8 wherein the folder includes a cross-folding device cross folding each printed product to form folded broadsheet newspapers.

10. The printing press recited in claim 1 further comprising a cutter downstream of the at least one printing unit cutting the web to separate the web portions from one another, the storage unit including a plurality of rewind units, each of the web portions being stored separately from one another by one of the rewind units, the folder including at least one former and a cross-cutting device, the folder receiving the plurality web portions from the plurality of rewind units at the same time, longitudinally folding and combing all of the web portions and cross-cutting the longitudinally folded and combined web portions to form the plurality of printed products.

11. The printing press recited in claim 1 wherein the at least one printing unit prints the web such that at least one of the web portions is printed with the same content repeatedly and each of the plurality of printed products includes at least four pages of the same content.

12. The printing press recited in claim 1 wherein the web portions include a first web portion and a second web portion, the first web portion including a plurality of successive first subportions and the second web portion including a plurality of successive second subportions, each of the first subportions including four pages of content, each of the second subportions including four pages of content, the folder acting on the first and second web portions such that each printed product includes one of the first subportions and one of the second subportions, the four pages of content of each of the first subportions forming a first, a second, a last and a second to last page of each printed product, the four pages of content of each of the second subportions forming a third, a fourth, a third to last and a fourth to last page of each printed product.

13. The printing press recited in claim 12 wherein the first subportions are all printed with the same content, such that each of the four pages of content of each first subportion are the same as the four pages of content of the other first subportions, the second subportions being all printed with the same content, such that each of the four pages of content of each second subportion are the same as the four pages of content of the other second subportions.

14. The printing press recited in claim 12 wherein at least some of the first subportions are printed with different content than each other, such that the four pages of content of at least some of the first subportions are different from the four pages of content of at least some of the other first subportions, at least some of the second subportions being printed with different content than each other, such that the four pages of content of at least some of the second subportions are different from the four pages of content of at least some of the other second subportions.

15. The printing press recited in claim 1 wherein the printing unit is a digital print engine.

16. The printing press recited in claim 1 wherein the printing unit is a non-digital printing unit.

17. The printing press recited in claim 1 wherein each of the groups of pages includes four pages, two pages being printed on a first side of the web and two pages being printed on a second side of the web.

18. The printing press recited in claim 17 wherein the folder longitudinally folds the web portions such that folds are formed in each of the groups of pages along a line dividing the two pages on the first side of the web from each other and the two pages on the second side of the web from each other.

19. The printing press recited in claim 18 wherein the folder cross-cuts the web portions together along a leading edge of one group of pages of each of the web portions and then a trailing edge of the one group of pages of each of the web portions to form one of the printed products.

20. The printing press recited in claim 19 wherein each of the printed products includes a number of pages equal to four times a number of the web portions.

21. The printing press recited in claim 1 wherein each of the plurality of web portions is printed with different content than the other plurality of web portions

22. A method of creating newspapers comprising:
printing on a plurality of successive web portions, each of the web portions being printed with a plurality of groups of pages, each web portion being printed with different content than at least one other of the plurality of web portions;
storing the web portions;
longitudinally folding the web portions and merging the longitudinally folded web portions together;
cutting the merged longitudinally folded web portions into a plurality of printed products, each of the printed products including one group of pages from each of the web portions.

23. The method recited in claim 22 wherein the step of storing the web portions includes rewinding each of the web portions around a different rewinding unit.

24. The method recited in claim 23 wherein the step of longitudinally folding the web portions and merging the longitudinally folded web portions together includes longitudinally folding some of the web portions with a first former, longitudinally folding others of the web portions with a second former and merging all of the longitudinally folded webs downstream of the first former and the second former.

25. The method recited in claim 22 wherein each web portion includes a plurality of subportions and the printing step includes printing one of the groups of pages in each subportion.

26. The method recited in claim 25 wherein each web portion is printed with the same group of pages repeatedly such that all of the subportions of each web portion include one group of pages that is the same as all of the other subportions of the web portion and each web portion includes a different group of pages than the other web portions, each printed product include one group of pages from each of web portion, each printed product including the same pages as the other printed products.

27. The method recited in claim 22 wherein the plurality of web portions includes a first web portion including subportions, all of the subportions of the first web portion being printed with the same group of pages.

28. The method recited in claim 27 wherein the plurality of web portions includes a second web portion including subportions, at least some of the subportions of the second web portion being printed with different groups of pages.

29. The method recited in claim 22 wherein each of the plurality of web portions is printed with different content than the other plurality of web portions
